(19) United States
(12) Patent Application Publication
(10) Pub. No.: US 2018/0281709 A1
(43) Pub. Date: Oct. 4, 2018

(54) VEHICLE HEAT SAFEGUARD

(71) Applicant: Ignacio Mendez, Los Angeles, CA (US)

(72) Inventor: Ignacio Mendez, Los Angeles, CA (US)

(21) Appl. No.: 15/478,221

(22) Filed: Apr. 3, 2017

(51) Int. Cl. B60R 16/037; B60R 25/20; B60N 2/00; B60J 1/12; G01K 3/00

(52) U.S. Cl. CPC B60R 16/037; B60R 25/209; G01K 3/005; B60J 1/12; B60N 2/002

(57) ABSTRACT

A vehicle safety system includes an ignition detector that detects when a vehicle ignition is off. A motion sensor detects movement within the vehicle. A first thermostat detects when temperature within the vehicle reaches a predetermined threshold. A remote start module starts a vehicle engine when the ignition detector detects the vehicle ignition is off, the motion sensor detects movement within the vehicle and the first thermostat detects temperature within the vehicle has reached the predetermined threshold.

### BACKGROUND

In sixty minutes, a closed vehicle left unattended can rise forty degrees Fahrenheit above the outside temperature. This means that a child or pet left unattended on a warm day for even a moderate amount of time can be put at risk for serious illness or death.

### BRIEF DESCRIPTION OF THE DRAWINGS

FIG. 1 illustrates a pet left in an unattended and parked vehicle.

FIG. 2 is a simplified flowchart that illustrates functionality of a vehicle heat safeguard in accordance with an implementation.

FIG. 3, including FIG. 3A, FIG. 3B, FIG. 3C and FIG. 3D, is a simplified circuit diagram for a vehicle heat safeguard in accordance with an implementation.

FIG. 4 is a circuit diagram for a remote start circuit in accordance with the prior art.

### DESCRIPTION OF THE EMBODIMENT

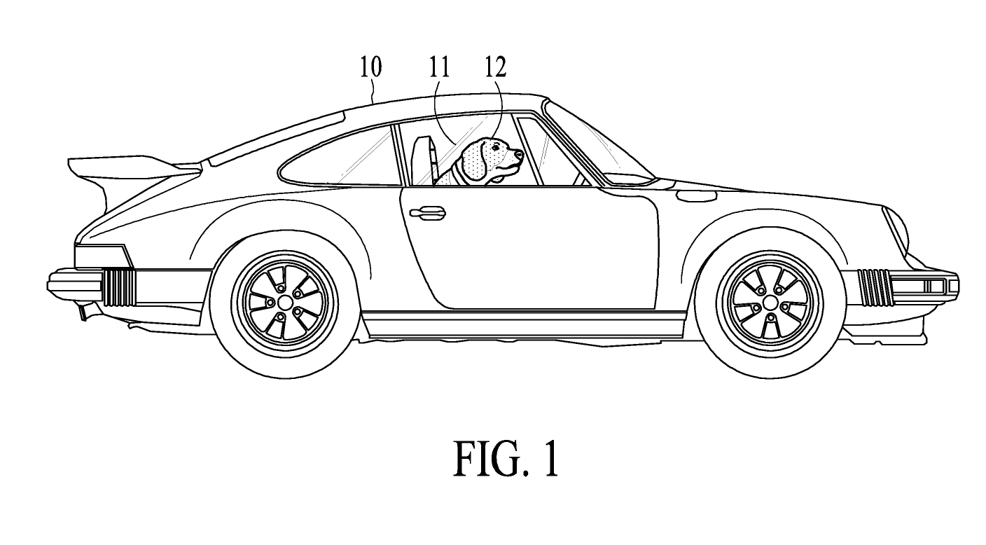

FIG. 1 shows a pet 12 visible through a window 11 of a vehicle 10. Parking vehicle 10 and leaving pet 12 unattended on a warm day can place pet 12 in danger of serious illness or death from heat stroke. For example, vehicle 10, is a car, van, minivan, truck, motorhome, or other type of vehicle with an enclosed cabin. A child left unattended in a vehicle faces a similar risk.

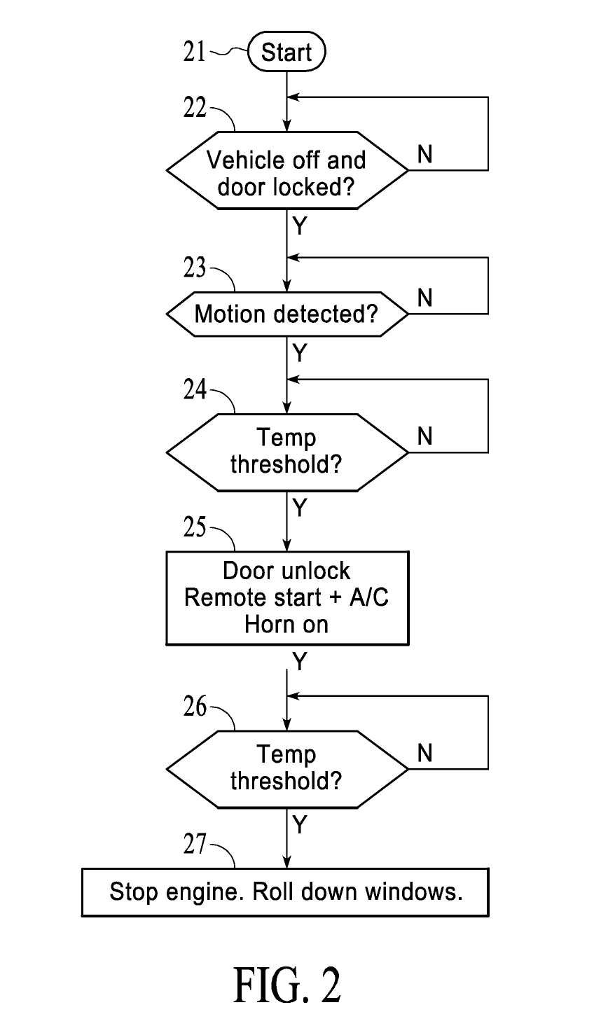

FIG. 2 is a simplified flowchart that illustrates functionality of a vehicle heat safeguard. The process is originated in a block 21. In a block 22, the vehicle is monitored to determine when the vehicle is off and the doors are closed. Alternatively, in block 22, the vehicle is monitored to determine when the vehicle is off and the doors are closed and locked. When in block 22 the vehicle is off and the doors are closed, in a block 23, a motion sensor monitors motion within the vehicle to detect movement. When motion is detected in block 23 and a temperature threshold is reached in a block 24, this indicates the potential of a pet or possibly even a child has been left unattended in a vehicle that is at an unsafe interior temperature. In a block 25, one or more of the car doors are unlocked. The car is remote started so that the air conditioner can run. Also, the horn is activated to periodically beep. Also, in a block 26 the temperature in the vehicle continues to be monitored. If a second temperature threshold is reached, or if after a certain time there is not a predetermined amount of reduction in the internal temperature of the vehicle, in a block 27, the windows of the vehicle are rolled down and the engine is turned off. For example, the windows of the vehicle are rolled down three or four inches to allow airflow through the vehicle interior to cool the vehicle interior. Once the vehicle doors are opened, the horn stops beeping and the vehicle heat safeguard is turned off. Once the door is again closed and the engine is off, the vehicle system restarts in block 21.

In FIG. 2, the order of block 22, block 23 and block 24 may be adjusted. The checks done in block 22, block 23 and block 24 can be done in any order and may be performed in parallel. Additionally, in various implementations, some checks performed in block 22, block 23 and block 24 may be omitted. For example, in block 22, in one implementation the vehicle is monitored to determine when the vehicle is off, but is not monitored to determine whether the doors are closed.

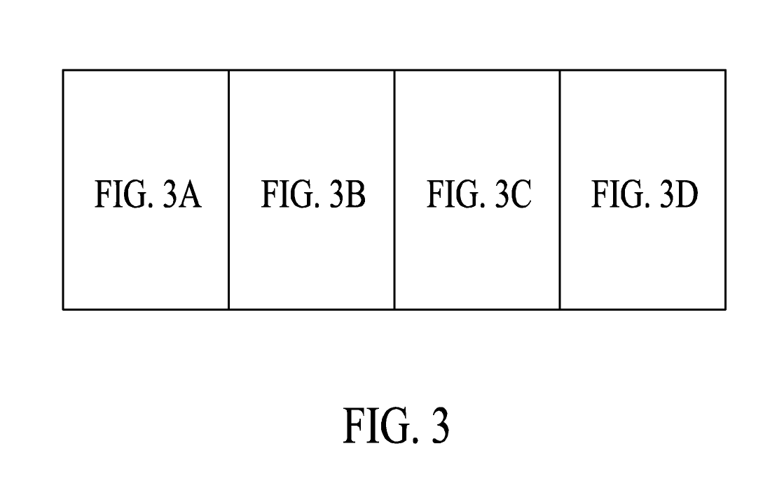

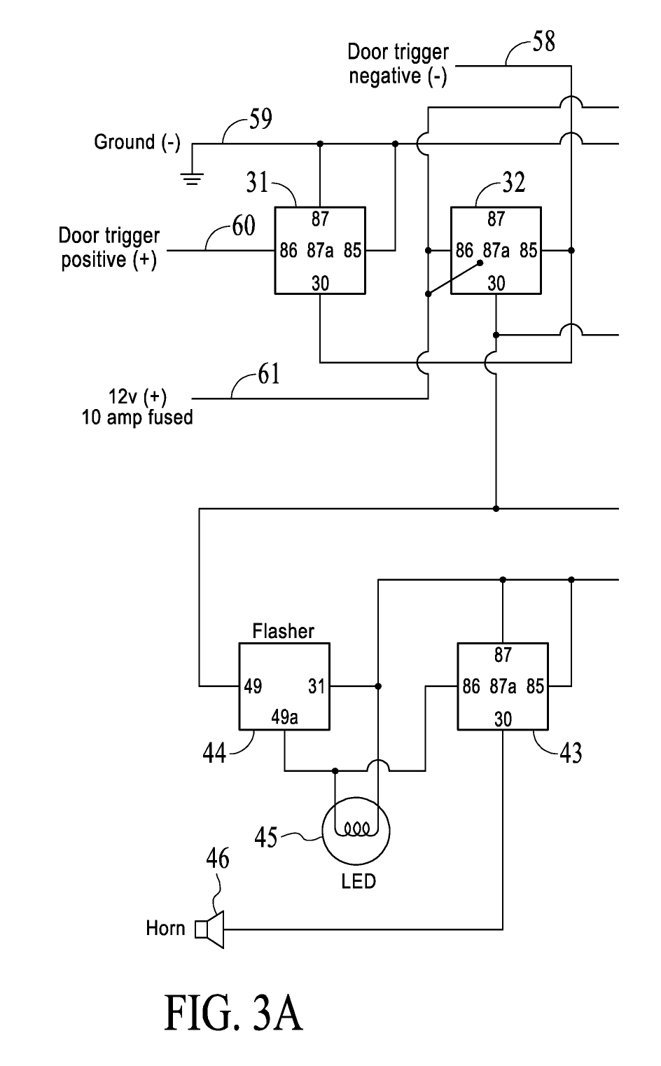

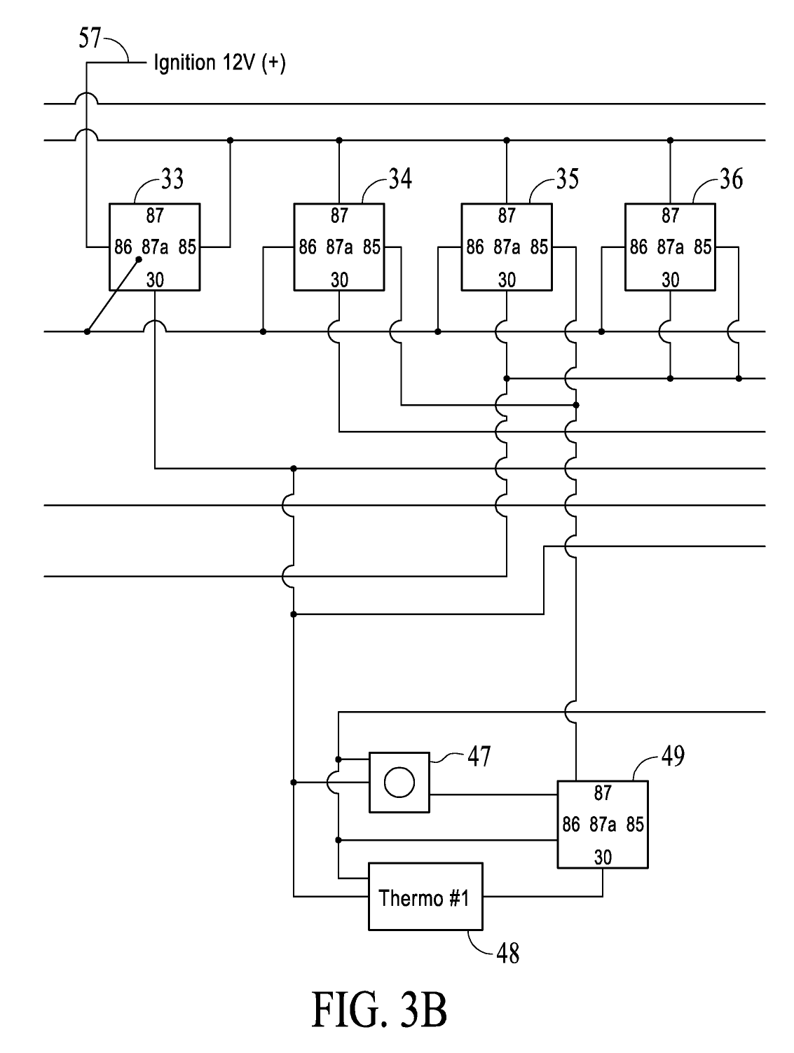

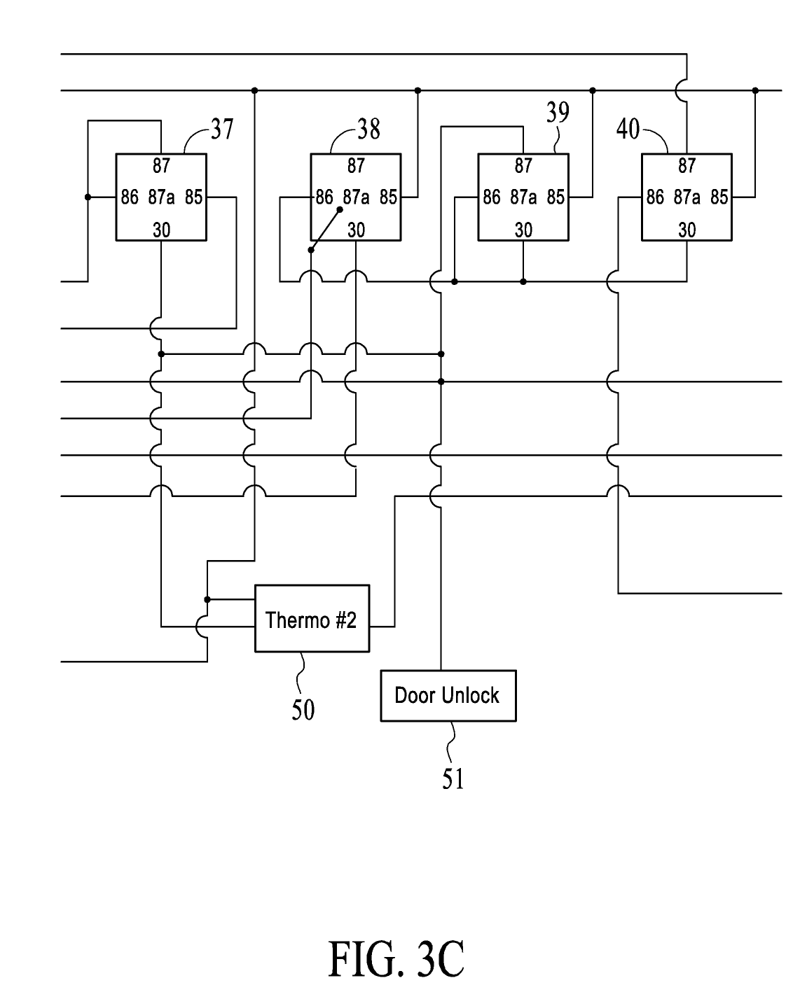

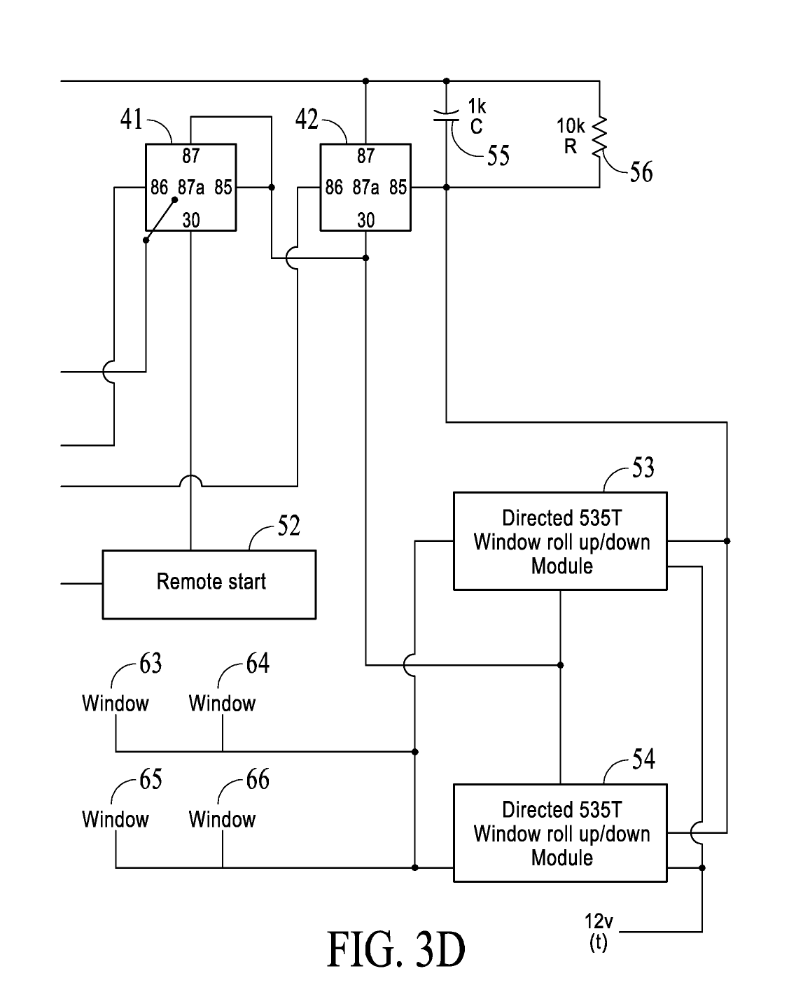

FIG. 3 shows a simplified circuit diagram of an implementation of a vehicle heat safeguard system. The system includes a relay 31, a relay 32, a relay 33, a relay 34, a relay 35, a relay 36, a relay 37, a relay 38, a relay 39, a relay 40, a relay 41, a relay 42, a relay 43. A flasher circuit 44, a light emitting diode (LED) 45, a horn 46, a motion sensor 47, a thermostat 48, a trigger output module 49, a thermostat 50, a door unlock circuit 51, a remote start module 52, a window control module 53, a window control module 54, a capacitor 55, a resistor 56, a line 57 that carries a 12 volt ignition voltage, a line 58 that carries a door trigger negative voltage, a line 59 that carries a ground signal, a line 60 that carries a door trigger positive signal, a line 61 that carries a 12 volt DC signal, a line 62 that carries a 12 volt DC signal, a vehicle window control 63, a vehicle window control 64, a vehicle window control 65 and a vehicle window control 66, connected as shown.

For example, relays 31 through 43 are off the shelf available relays such as Hella H415100171 Dual 87 12V 40 Amp SPST Relays. For example, flasher circuit 44 is a flasher such as a Novita EP36 flasher. For example, LED 45 is a vehicle light visible from outside the vehicle. For example, horn 46 is the vehicle horn. For example, motion sensor 47 is a twelve-volt motion sensor that senses motion anywhere in the vehicle. For example, thermostat 48 and thermostat 50 are each a WILLHI WK7016C1 AC Digital Temperature Controller Thermostat with Sensor Probe or similar thermostat that runs on a twelve-volt power supply. For example, trigger output module 49 is a Pac TR7 universal trigger output module. For example, door unlock circuit 51 is the door unlock circuit for the vehicle. For example, remote start module 52 is a Viper Alarm 9906V remote start or similar remote start circuit. For example, window control module 53 and window control module 54 are each a Directed Electronics 535T Power Window Automation System or similar power window automation system used to roll up and roll down vehicle windows. For example, capacitor 55 provides 1000 microfarad capacitance. For example, resistor 56 provides ten kilohms of resistance.

For example, relay 43 provides a ground voltage (also referred to herein as a negative output) to horn 46 to trigger horn 46 to beep. Thermostat 48 provides a positive output to trigger output module 49. Thermostat 48 is used to detect when temperature within the vehicle reaches a predetermined threshold. The threshold, for example, might be 110 degrees Fahrenheit, or any other predetermined temperature. For example, motion sensor 47 provides a positive 3.0+/− volt output to a positive 0.8-16.0 volts input of trigger output module 49. For example, a 150-milliamp maximum ground (negative output) signal from trigger output module 49 is used to activate relay 34 and relay 35. For example, a negative output from relay 34 to relay 41 is used to activate remote start module 52 and the negative output from relay 34 is used to activate door unlock circuit 51.

Negative output from relay 41 is used to activate remote start activation 52. Positive output from thermostat 50 activates relay 42 to deactivate remote start module 52 through relay 41, and is used to activate window control module 53 and window control module 54. Thermostat 50 is used to detect when temperature within the vehicle reaches a predetermined threshold. The threshold, for example, might be 115 degrees Fahrenheit, or any other predetermined temperature. Output from window control module 53 and window control module 54 rolls down windows 63 through 66. Remote start module 52 provides a positive start output to starter and to relay 40 to deactivate thermostat B, which receives the deactivation signal from relay 40 through relay 38. A positive signal from relay 37 activates thermostat 50. Relay 31 and relay 32 serve as a closed-door detector that detects when car doors are closed. Alternatively, relay 31 and relay 32 detect when car doors are closed and locked. Relay 33 and relay 38 serve as an ignition detector that detects when vehicle ignition is off.

Incorporated into remote start module 52, or incorporated into a separate module between remote start module 52 and the car ignition, is an immobilizer override. The immobilizer override allows the need for a key to be bypassed so that the car thinks the key is in the ignition or a smart key is within close vicinity to the car so the car can be started without a key.

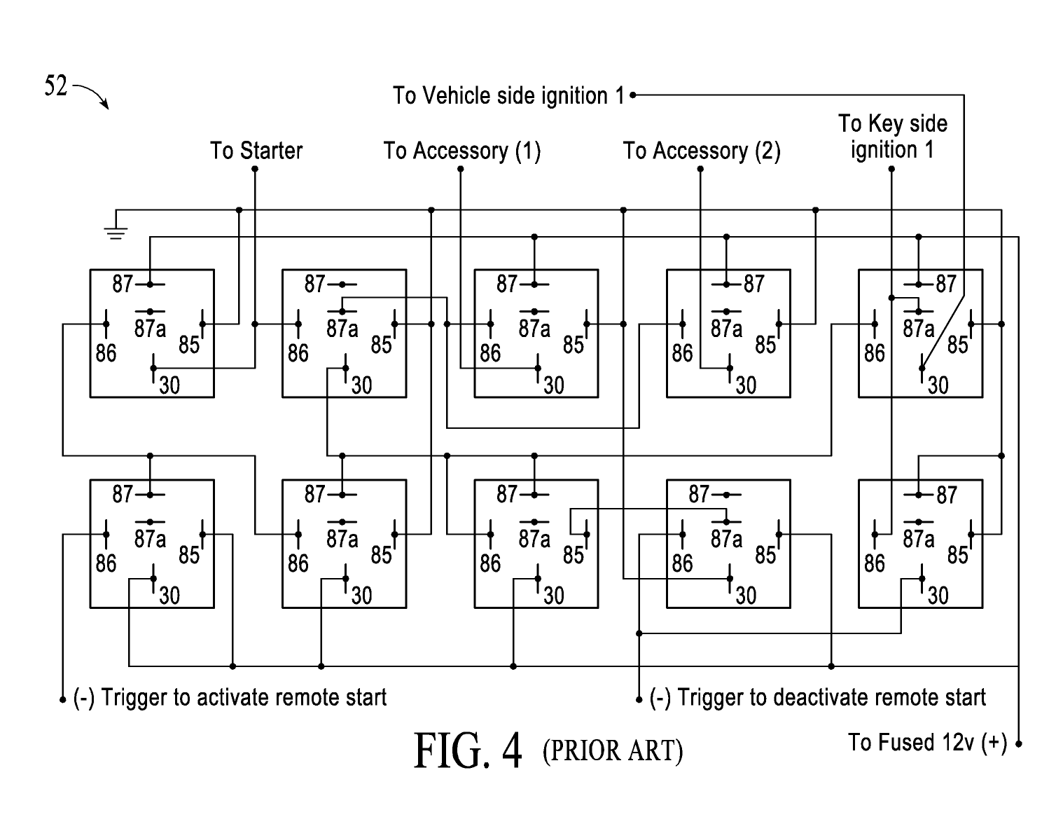

FIG. 4 is a circuit diagram that shows remote start circuit 52 being implemented with a remote start circuit known in the prior art. See http://www.the12volt.com/relays/relaydiagram33.html.

The foregoing discussion discloses and describes merely exemplary methods and embodiments. As will be understood by those familiar with the art, the disclosed subject matter may be embodied in other specific forms without departing from the spirit or characteristics thereof. Accordingly, the present disclosure is intended to be illustrative, but not limiting, of the scope of the invention.

What is claimed is:

1. A vehicle safety system comprising:
an ignition detector that detects when a vehicle ignition is off;
a motion sensor that detects movement within the vehicle;
a first thermostat that detects when temperature within the vehicle reaches a predetermined threshold; and,
a remote start module that starts a vehicle engine when the ignition detector detects the vehicle ignition is off, the motion sensor detects movement within the vehicle and the first thermostat detects temperature within the vehicle has reached the predetermined threshold.

2. A vehicle safety system as in claim 1 additionally comprising:
a closed-door detector that detects when doors of the vehicle are closed;
wherein the remote start module starts the vehicle engine when the ignition detector detects the vehicle ignition is off, the closed-door detector detects that the doors of the vehicle are closed, the motion sensor detects movement within the vehicle and the first thermostat detects temperature within the vehicle has reached the predetermined threshold.

3. A vehicle safety system as in claim 1 additionally comprising:
a flasher circuit that beeps a horn for the vehicle when the ignition detector detects the vehicle ignition is off, the motion sensor detects movement within the vehicle and the first thermostat detects temperature within the vehicle has reached the predetermined threshold.

4. A vehicle safety system as in claim 1 additionally comprising:
a flasher circuit that beeps a horn for the vehicle and flashes vehicle lights when the ignition detector detects the vehicle ignition is off, the motion sensor detects movement within the vehicle and the first thermostat detects temperature within the vehicle has reached the predetermined threshold.

5. A vehicle safety system as in claim 1 additionally comprising:
a second thermostat that detects when temperature within the vehicle reaches a second predetermined threshold, the second thermostat being activated when the ignition detector detects the vehicle ignition is off, the motion sensor detects movement within the vehicle and the first thermostat detects temperature within the vehicle has reached the predetermined threshold; and,
a window control module that rolls down windows of the vehicle when the second thermostat is activated and detects temperature within the vehicle has reached the second predetermined threshold;
wherein the remote start module stops the vehicle engine when the second thermostat is activated and detects temperature within the vehicle has reached the second predetermined threshold.

6. A vehicle safety system as in claim 1 additionally comprising:
a closed-door detector that detects when doors of the vehicle are closed and locked;
wherein the remote start module starts the vehicle engine when the ignition detector detects the vehicle ignition is off, the closed-door detector detects that the doors of the vehicle are closed and locked, the motion sensor detects movement within the vehicle and the first thermostat detects temperature within the vehicle has reached the predetermined threshold.

7. A method for providing vehicle safety, comprising:
detecting with an ignition detector when a vehicle ignition is off;
detecting, with a motion sensor, movement within the vehicle;
detecting with a thermostat when temperature within the vehicle reaches a predetermined threshold; and,
staring a vehicle engine when the ignition detector detects the vehicle ignition is off, the motion sensor detects movement within the vehicle and the first thermostat detects temperature within the vehicle has reached the predetermined threshold.

8. A method as in claim 7 additionally comprising:
beeping a horn for the vehicle when the ignition detector detects the vehicle ignition is off, the motion sensor detects movement within the vehicle and the first thermostat detects temperature within the vehicle has reached the predetermined threshold.

9. A method as in claim 7 additionally comprising:
beeping a horn for the vehicle and flashing vehicle lights when the ignition detector detects the vehicle ignition is off, the motion sensor detects movement within the vehicle and the first thermostat detects temperature within the vehicle has reached the predetermined threshold.

10. A method as in claim 7 additionally comprising:
detecting, with a second thermostat, when temperature within the vehicle reaches a second predetermined threshold, the second thermostat being activated when the ignition detector detects the vehicle ignition is off, the motion sensor detects movement within the vehicle and the first thermostat detects temperature within the vehicle has reached the predetermined threshold;
rolling down windows of the vehicle when the second thermostat is activated and detects temperature within the vehicle has reached the second predetermined threshold; and,
stopping the vehicle engine when the second thermostat is activated and detects temperature within the vehicle has reached the second predetermined threshold.

11. A method as in claim 7 additionally comprising:
detecting, with a closed-door detector, when doors of the vehicle are closed; and,
starting the vehicle engine when the ignition detector detects the vehicle ignition is off, the closed-door detector detects that the doors of the vehicle are closed, the motion sensor detects movement within the vehicle and the first thermostat detects temperature within the vehicle has reached the predetermined threshold.

12. A method as in claim 7 additionally comprising:
detecting, with a closed-door detector, when doors of the vehicle are closed and locked; and,
starting the vehicle engine when the ignition detector detects the vehicle ignition is off, the closed-door detector detects that the doors of the vehicle are closed and locked, the motion sensor detects movement within the vehicle and the first thermostat detects temperature within the vehicle has reached the predetermined threshold.

13. A vehicle safety system comprising:
a plurality of relays;
an ignition detector that detects when a vehicle ignition is off;
a motion sensor that detects movement within the vehicle;
a first thermostat that detects when temperature within the vehicle reaches a predetermined threshold; and,
a remote start module that starts a vehicle engine;
wherein the plurality of relays is connected to the ignition detector, the motion sensor, the first thermostat and the remote start module so that when the ignition detector detects the vehicle ignition is off, the motion sensor detects movement within the vehicle and the first thermostat detects temperature within the vehicle has reached the predetermined threshold.

14. A vehicle safety system as in claim 13 additionally comprising:
a closed-door detector that detects when doors of the vehicle are closed;
wherein the plurality of relays is connected to the closed-door detector so that when the ignition detector detects the vehicle ignition is off, the closed-door detector detects that the doors of the vehicle are closed, the motion sensor detects movement within the vehicle and the first thermostat detects temperature within the vehicle has reached the predetermined threshold.

15. A vehicle safety system as in claim 13 additionally comprising:
a flasher circuit that beeps a horn for the vehicle;
wherein the plurality of relays is connected to the flasher circuit so that when the ignition detector detects the vehicle ignition is off, the motion sensor detects movement within the vehicle and the first thermostat detects temperature within the vehicle has reached the predetermined threshold, the flasher circuit beeps the horn for the vehicle.

16. A vehicle safety system as in claim 13 additionally comprising:
a flasher circuit that beeps a horn for the vehicle and flashes vehicle lights;
wherein the plurality of relays is connected to the flasher circuit so that when the ignition detector detects the vehicle ignition is off, the motion sensor detects movement within the vehicle and the first thermostat detects temperature within the vehicle has reached the predetermined threshold, the flasher circuit beeps the horn for the vehicle and flashes vehicle lights.

17. A vehicle safety system as in claim 13 additionally comprising:
a second thermostat that detects when temperature within the vehicle reaches a second predetermined threshold, wherein the plurality of relays is connected to the second thermostat so that the second thermostat is activated when the ignition detector detects the vehicle ignition is off, the motion sensor detects movement within the vehicle and the first thermostat detects temperature within the vehicle has reached the predetermined threshold;
a window control module that rolls down windows of the vehicle, wherein the plurality of relays is connected to the window control module so that the window control module rolls down windows of the vehicle when the second thermostat is activated and detects temperature within the vehicle has reached the second predetermined threshold;
wherein the plurality of relays is connected to the remote start module so that the remote start module stops the vehicle engine when the second thermostat is activated and detects temperature within the vehicle has reached the second predetermined threshold.

18. A vehicle safety system as in claim 13 additionally comprising:
a closed-door detector that detects when doors of the vehicle are closed and locked;
wherein the plurality of relays is connected to the closed-door detector so that when the ignition detector detects the vehicle ignition is off, the closed-door detector detects that the doors of the vehicle are closed and locked, the motion sensor detects movement within the vehicle and the first thermostat detects temperature within the vehicle has reached the predetermined threshold.
